(19) United States
(12) Patent Application Publication
(10) Pub. No.: US 2015/0324229 A1
(43) Pub. Date: Nov. 12, 2015

(54) PROPAGATION OF TASK PROGRESS THROUGH THE USE OF COALESCED TIME INTERVALS

(71) Applicant: INTERNATIONAL BUSINESS MACHINES CORPORATION, Armonk, NY (US)

(72) Inventor: Thomas N. VALINE, Santa Clara, CA (US)

(73) Assignee: INTERNATIONAL BUSINESS MACHINES CORPORATION, Armonk, NY (US)

(21) Appl. No.: 14/273,862

(22) Filed: May 9, 2014

(51) Int. Cl. G06F 9/48

(52) U.S. Cl. CPC G06F 9/4887

(57) ABSTRACT

Approaches are provided for calculating a corresponding date of progress towards completion of a task regardless of a quantity being used to track the progress. An approach includes enumerating a list of time intervals for each sub-task of at least one summary task. The approach further includes distributing a progress value over a duration of each sub-task. The approach further includes creating, by at least one computing device, a coalesced set of time intervals for the at least one summary task based on the list of time intervals enumerated for each sub-task. The approach further includes traversing the coalesced set of time intervals and accumulating portions of the progress value until a required progress is obtained. The approach further includes determining a date of progress for the at least one summary task based on the accumulated portions of the progress value.

### FIELD OF THE INVENTION

The present invention generally relates to project management, and more particularly, to a method and system for calculating a corresponding date of progress towards completion of a task regardless of a quantity being used to track the progress.

### BACKGROUND

The Program (or Project) Evaluation and Review Technique (PERT) is a statistical tool, used in project management, that is designed to analyze and represent the tasks involved in completing a given project. In the context of PERT project management methodology, a project plan can be organized using a hierarchical tree of tasks and sub-tasks. Tasks having no descendant tasks (e.g., sub-tasks) are referred to as leaf tasks and tasks having one or more descendent tasks are referred to as summary tasks. Descendent tasks of summary tasks may be either leaf tasks or summary tasks. The project plan hierarchy is typically scheduled so that all tasks and sub-tasks have scheduled start and end dates.

When marking the current progress towards completion (e.g., as a percentage of total summary task duration) of a summary task having a start date and an end date, a corresponding date of progress that lies between the start and end dates of the summary task may be calculated. Once this date of progress is calculated, all tasks in the summary task sub-tree may be marked as completed up to the calculated date of progress. The variable used for tracking progress may be duration, work, or any other quantity associated with the task and is allocated to the task between the start and end dates of the task. However, the conventional systems and methods for calculating the corresponding date of progress and identifying the tasks completed involve complex computations that are dependent upon the variable used for tracking progress.

### SUMMARY

In a first aspect of the invention, there is a method that includes enumerating a list of time intervals for each sub-task of at least one summary task. The method further includes distributing a progress value over a duration of each sub-task. The method further includes creating, by at least one computing device, a coalesced set of time intervals for the at least one summary task based on the list of time intervals enumerated for each sub-task. The method further includes traversing the coalesced set of time intervals and accumulating portions of the progress value until a required progress is obtained. The method further includes determining a date of progress for the at least one summary task based on the accumulated portions of the progress value.

In another aspect of the invention, there is a computer program product for calculating a date of progress for at least one summary task. The computer program product includes a computer readable storage medium having program instructions embodied in the storage medium. The program code is executable by at least one computing device to schedule all tasks of a task hierarchy including the at least one summary task, enumerate a list of time intervals for each sub-task of the at least one summary task, and distribute a progress value over a duration of each sub-task. The program code is also executable by the at least one computing device to calculate a required progress for the progress value based on an identified value of total progress, create a list of unique interval dates based on the enumerated list of time intervals for each sub-task, and create a coalesced set of time intervals for the at least one summary task based on the list of unique interval dates. The program code is also executable by the at least one computing device to propagate portions of the progress value that are distributed over the duration of each sub-task into each time interval of the coalesced set of time intervals, traverse the coalesced set of time intervals and accumulate the portions of the progress value until the required progress is obtained, and determine the date of progress for the summary task based on the accumulated portions of the progress value.

In a further aspect of the invention, there is a computer system for calculating a date of progress for at least one summary task. The system includes a CPU, a computer readable memory and a computer readable storage medium. Additionally, the system includes one or more program instructions. The program instructions are operable to enumerate a list of time intervals for each sub-task of at least one summary task. The program instructions are further operable to distribute a progress value over a duration of each sub-task. The program instructions are further operable to create a list of unique interval dates based on the enumerated list of time intervals for each sub-task. The program instructions are further operable to create a coalesced set of time intervals for the at least one summary task based on the list of unique interval dates. The program instructions are further operable to allocate portions of the progress value that are distributed over the duration of each sub-task to each time interval of the coalesced set of time intervals. The program instructions are further operable to traverse the coalesced set of time intervals and accumulate the portions of the progress value until a required progress is obtained. The program instructions are further operable to determine a date of progress for the at least one summary task based on the accumulated portions of the progress value. The program instructions are further operable to traverse the time intervals for each sub-task and mark the time intervals completed up to the determined date of progress. The program instructions are stored on the computer readable storage medium for execution by the CPU via the computer readable memory.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with aspects of the invention.

FIG. 2 shows an exemplary flow in accordance with aspects of the invention.

FIGS. 3-7 show an exemplary propagation of summary task progress through the use of coalesced time intervals in accordance with aspects of the invention.

FIG. 8 shows an exemplary flow in accordance with aspects of the invention.

FIGS. 9-15 show an exemplary propagation of summary task progress through the use of coalesced time intervals in accordance with aspects of the invention.

### DETAILED DESCRIPTION

The present invention generally relates to project management, and more particularly, to a method and system for calculating a corresponding date of progress towards completion of a task regardless of a quantity being used to track the progress. More specifically, implementations of the invention provide systems and methods for tracking progress of a quantity over duration of a task (e.g., a summary task). In embodiments, the quantity may be any variable allocated over an entire duration of a task such as work, cost, duration, resources, etc. In accordance with these aspects of the present invention, the quantity provides a variable that may be used to track the progress of the task towards completion. To this end, in embodiments, a list of time intervals may be enumerated for each sub-task or descendant task of the task that range from the start to the end of the task and track a portion of a chosen quantity that is allocated during any given duration of the task. The list of time intervals enumerated for each sub-task or descendant task may be coalesced into a single set of equivalent time intervals for the task, which allows for a date to be determined that corresponds to the progress of the chosen quantity. Advantageously, in embodiments, the systems and methods of the present invention allow for the sub-tasks to be examined and the time intervals to be marked as completed up until the date that corresponds to the progress of the chosen quantity.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

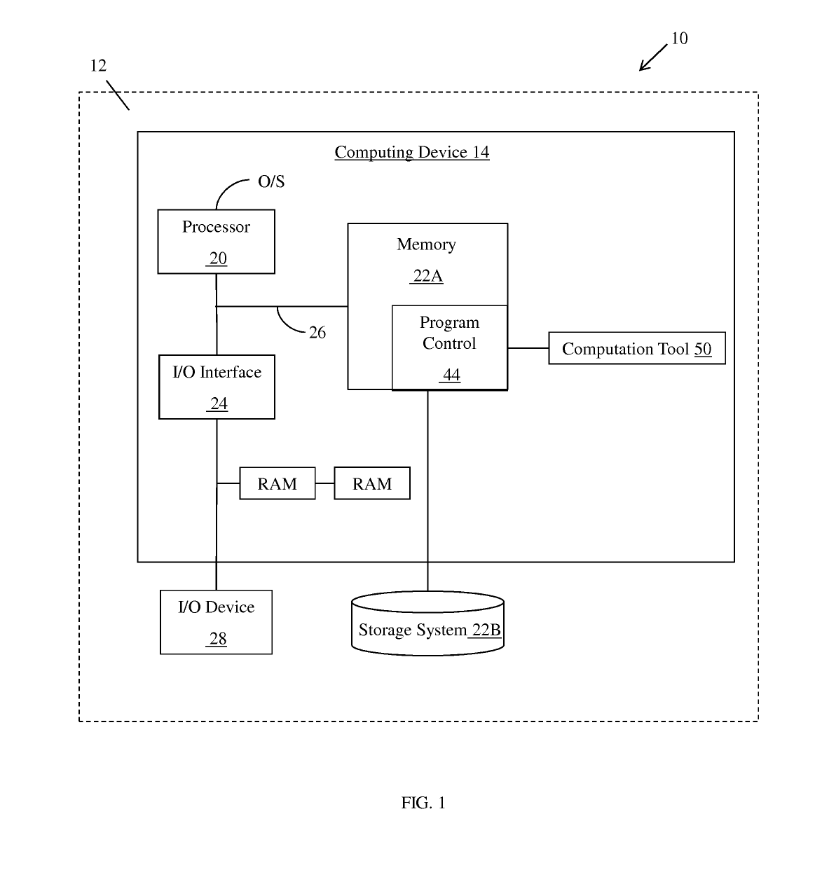

FIG. 1 shows an illustrative environment 10 for managing the processes in accordance with the invention. To this extent, environment 10 includes a server 12 or other computing system that can perform the processes described herein. In particular, server 12 includes a computing device 14. The computing device 14 can be resident on a network infrastructure or computing device of a third party service provider (any of which is generally represented in FIG. 1).

The computing device 14 also includes a processor 20 (e.g., CPU), memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with external I/O device/resource 28 and storage system 22B. For example, I/O device 28 can comprise any device that enables an individual to interact with computing device 14 (e.g., user interface) or any device that enables computing device 14 to communicate with one or more other computing devices using any type of communications link. The external I/O device/resource 28 may be for example, a handheld device, PDA, handset, keyboard etc.

In general, processor 20 executes computer program code (e.g., program control 44), which can be stored in memory 22A and/or storage system 22B. Moreover, in accordance with aspects of the invention, program control 44 controls a computation tool 50, e.g., at least a portion of a project management application such as IBM Program Work Center™ or IBM Merger &Acquisition Accelerator (IBM and IBM Program Work Center are trademarks of International Business Machines Corporation registered and unregistered in many jurisdictions worldwide), which performs the processes described herein. The computation tool 50 can be implemented as one or more program code in program control 44 stored in memory 22A as separate or combined modules. Additionally, the computation tool 50 may be implemented as separate dedicated processors or a single or several processors to provide the function of the tool. While executing the computer program code, the processor 20 can read and/or write data to/from memory 22A, storage system 22B, and/or I/O interface 24. The program code executes the processes of the invention. The bus 26 provides a communications link between each of the components in computing device 14.

In embodiments, the computation tool 50 can calculate a corresponding date of progress towards completion of a task regardless of a quantity being used to track the progress. For example in accordance with aspects of the present invention, the computation tool 50 may be configured to enumerate a list of time intervals for each scheduled sub-task of a task hierarchy, calculate a required progress for a progress variable based on an identified value of total progress, create a coalesced set of time intervals for a summary task, traverse the coalesced set of time intervals and accumulate portions of the progress variable until the required progress is reached, and determine the date of progress for the summary task based on the accumulated portions of the progress variable.

The computing device 14 can comprise any general purpose computing article of manufacture capable of executing computer program code installed thereon (e.g., a personal computer, server, etc.). However, it is understood that computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, server 12 is only illustrative of various types of computer infrastructures for implementing the invention. For example, in embodiments, server 12 comprises two or more computing devices (e.g., a server cluster) that communicate over any type of communications link, such as a network, a shared memory, or the like, to perform the process described herein. Further, while performing the processes described herein, one or more computing devices on server 12 can communicate with one or more other computing devices external to server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

### Flow Diagram

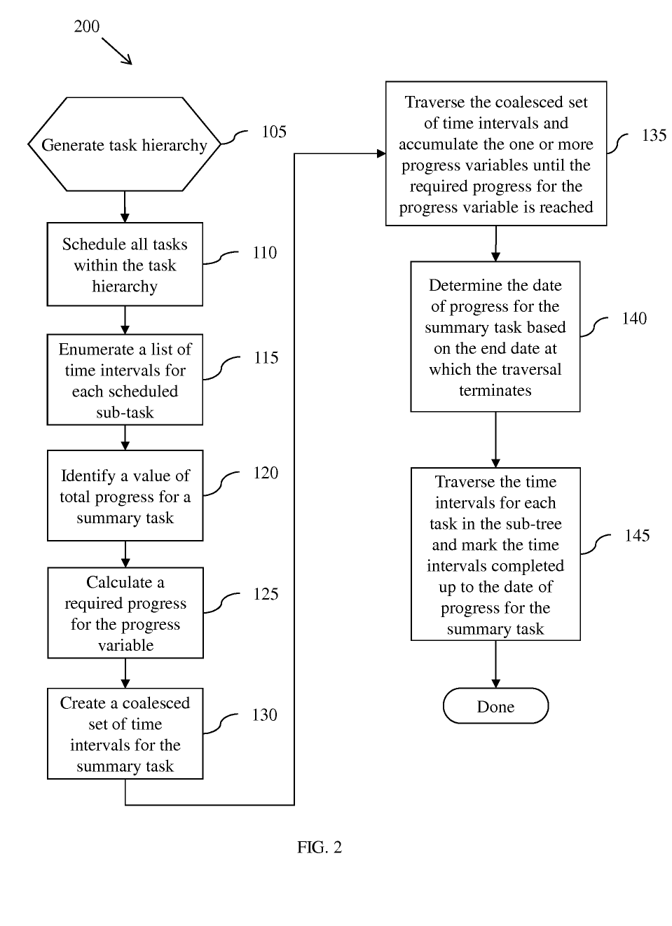

FIGS. 2 and 8 show exemplary flows for performing aspects of the present invention. The steps of FIGS. 2 and 8 may be implemented in the environment of FIG. 1, for example. As noted above, the flowchart(s) illustrate the architecture, functionality, and operation of possible implementations of systems, methods, and computer program products according to various embodiments of the present invention.

FIG. 2 depicts an exemplary flow for a process 100 in accordance with aspects of the present invention. At step 105, a task hierarchy for a project may be generated or obtained using a computing device. In embodiments, the task hierarchy may be generated by performing a work breakdown structure to identify tasks or activities involved in the project and a task or activity analysis of how each task or activity of the project (e.g., a project for generating a computer software program) is accomplished. The task analysis may include a detailed description of both manual and mental activities, task and element durations, task frequency, task allocation, task complexity, task cost, environmental conditions, necessary resources, e.g., materials and equipment, and any other unique factors involved in or required for one or more people to perform a given task. The task analysis provides a hierarchical representation of the steps it takes to perform a task for which there is a goal (e.g., error detection within software code) and for which there is some lowest-level “action” that is performed.

In additional or alternative embodiments, the task hierarchy for a project may be obtained and loaded into a computing device. For example, the task hierarchy for generating a computer software program may be loaded into the computation tool 50 (as discussed with respect to FIG. 1). The task hierarchy for the project may be found or provided by a project manager of the project.

At step 110, all tasks within the task hierarchy are scheduled using a scheduling methodology. In embodiments, the critical path methodology may be used to schedule the tasks. A critical path is the sequence of activities performed from start to end of a project, where a delay in completion of any tasks in the sequence would result in a delay of the overall project. Identifying the critical path gives the project manager a completion date of the project and flexibility to float activities. In embodiments, the scheduling of the tasks may include establishing an activity sequence performed from start to the end of a project. The activity sequence may be identified by determining which tasks should take place before a task happens, which tasks should be completed at the same time as a task, and which tasks should happen immediately after a task. Once the activity sequence is identified, a network diagram may be generated, as should be known by those of ordinary skill in the art of project management.

In embodiments, the scheduling of the tasks may further include obtaining activity duration estimates for each activity. The estimates may be a direct input from the work breakdown structure and task analysis. For example, a three-point estimation method or Constructive Cost Mode (COCOMO) model may be used within the work breakdown structure and task analysis for estimating effort, cost, and schedule. Once the activity duration estimates are obtained, the critical path may be identified using parameters such as earliest start time, earliest finish time, latest finish time, and latest start time, as should be known by those of ordinary skill in the art of project management. The critical path is the longest path of the network diagram. The activities in the critical path have an effect on the deadline of the project. If an activity of this path is delayed, the project will be delayed.

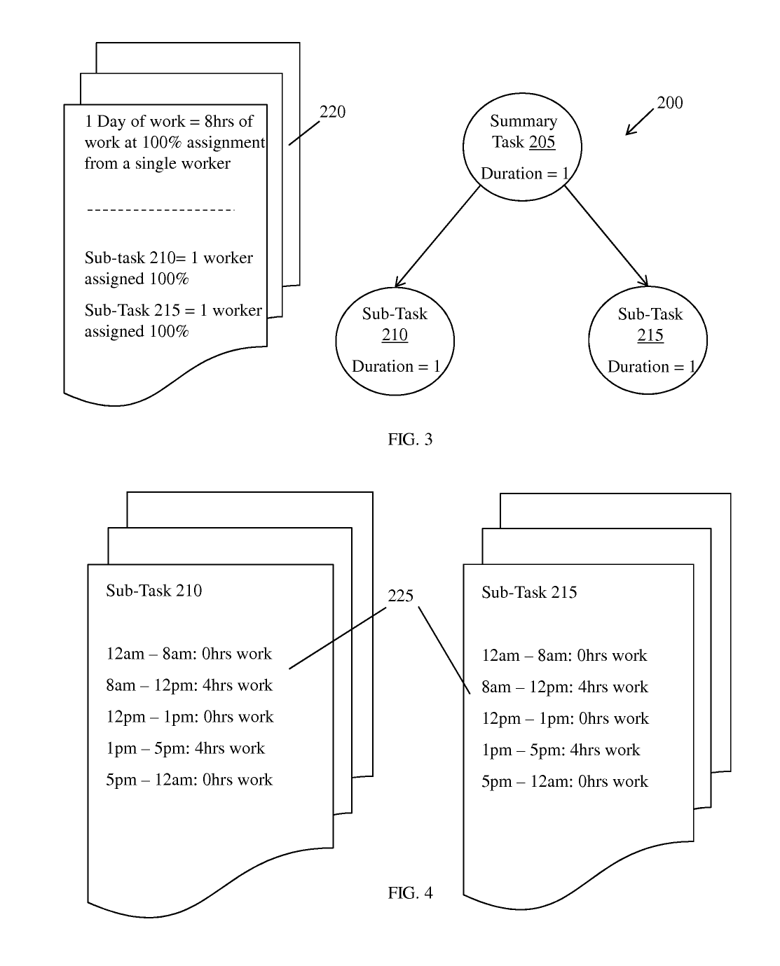

As a result of the scheduling and calculations described with respect to steps 105 and 110, all tasks of the project will have a scheduled start date, a scheduled end date, and a duration expressed in time units (e.g., minutes or tenths of minutes). This should result in all tasks having a cumulative value for all progress variables (e.g., work, duration, currency, etc.) that corresponds to the sum total of the sub-task values of those progress variables. For example, as illustrated in FIG. 3, the scheduling of an exemplary task hierarchy, as performed in step 110, may result in a network diagram 200 having a summary task 205 (e.g., a task with sub-tasks or descendants) with a duration of one day. The summary task 205 may include two sub-tasks 210 and 215 with no descendants (e.g., leaf tasks). The two sub-tasks 210 and 215 may both have a duration of one day and are capable of being performed simultaneously to complete the summary task 205 in one day. From the work breakdown structure 220 generated in step 105 it should be known that one day of work is equal to eight hours of work at 100% assignment from a single worker and one person is assigned 100% to work on sub-task 210 and one person is assigned 100% to work on sub-task 215. Therefore, the sub-tasks 210 and 215 each have a work value (i.e., a progress variable) of one work day or eight hours. Consequently, the cumulative work value of the summary task 205 is two work days or sixteen hours, which is the sum total of the work value for the sub-tasks 210 and 215.

This running example and all of the examples discussed herein are provided for illustrative purposes only, and many other exemplary implementations are possible without departing from the spirit and scope of the present invention. Moreover, although the exemplary flows and illustrative examples discussed herein pertain to summary tasks comprising descendant sub-tasks, it should be understood by one of ordinary skill in the art that the concepts discussed herein are also applicable to leaf tasks or tasks without any descendant sub-tasks.

At step 115, a list of time intervals (e.g., minutes, hours, days, etc) may be enumerated for each scheduled sub-task starting at the start date (e.g., start day of year and time of the start day) of the sub-task and finishing at the end date (e.g., end day of year and time of the end day) of the sub-task task. In embodiments, the enumerated listed of time intervals for each scheduled leaf task may be defined such that at least one of the following requirements is met: (1) each time interval has a start date and an end date that lies between the start date and end date of the leaf task, (2) each time interval has a start date that does not occur after the interval end date and an end date that does not occur before the interval start date, (3) each time interval has associated with it, a portion of one or more progress variables, e.g., work, duration, currency, etc., indicated for the entirety of the leaf task, (4) each time interval has an interval start date that is coincident with the end date of the previous time interval with the exception of the first time interval whose start date shall correspond to the start date of the leaf task, (5) each time interval has an interval end date that is coincident with the start date of the next interval with the exception of the last interval whose end date shall correspond to the end date of the task, and (6) each time interval represents progress that has been completed or progress that remains to be completed, but not both.

In embodiments, the enumeration of the list of time intervals for each sub-task may include distributing a quantity (e.g., one or more progress variables) over the duration of each scheduled sub-task. The distribution of the quantity may include identifying a portion of the quantity for at least one interval of time within in the list such that the list of time intervals tracks the portion of the quantity that is allocated during any given time interval of the sub-tasks. For example, as illustrated in FIG. 4 and continuing with the example discussed above, for sub-tasks 210 and 215, there may be five time intervals 225 enumerated that represent a time from 12 am-8 am, 8 am-12 pm, 12 pm-1 pm, 1 pm-5 pm, and 5 pm-12 am. Where work (i.e., the quantity) of the sub-tasks are distributed only to the Sam-12 pm and 1 pm-5 pm time intervals (e.g., working time), and no work is distributed to the 12 am-8 am, 12 pm-1 pm, and 5 pm-12 am time intervals (e.g., non-working time).

At step 120, a value of total progress is identified for a summary task. In embodiments, the value of total progress is representative of the total progress of performance for a summary task up to a given date, and may be identified as a value between and inclusive of 0% and 100%. The total progress may be entered by a project manager or task owner. For example, if a summary task is 50% completed then a project manager may enter the percentage into the computation tool 50 via I/O Device 28 (as discussed with respect to FIG. 1) for the summary task.

At step 125, a required progress for the progress variable may be calculated. In embodiments, the required progress for the indicated progress variable may be calculated by dividing the value of total progress identified in step 120 by one hundred, and multiplying the quotient by the cumulative value for all progress variables calculated in step 110. For example, continuing with the example discussed above, a value of 50% for total progress of the summary task 205 may be identified. The 50% total progress may be divided by 100 to obtain a 0.5 quotient, which is multiplied by the two cumulative work days calculated previously in step 110 to obtain one work day of required progress for the progress variable (i.e., work).

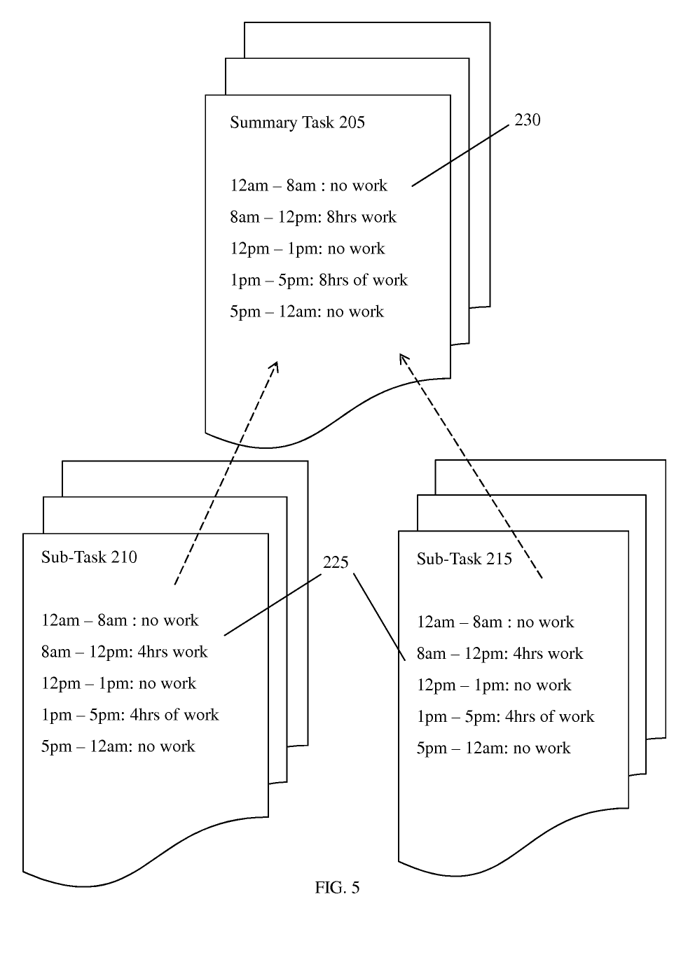

At step 130, a coalesced set of time intervals is created for the summary task, which is an equivalent representation of all intervals in the summary task sub-tree. In embodiments, the portions of the quantity that are allocated during any given time interval of the sub-tasks are propagated into the coalesced set of time intervals. For example, as illustrated in FIG. 5 and continuing with the example discussed above, for summary task 205, the five time intervals 225 from each of the sub-task 210 and the sub-task 215 are coalesced into a combined set of time intervals 230 comprising 12 am-8 am, 8 am-12 pm, 12 pm-1 pm, 1 pm-5 pm, and 5 pm-12 am. Where work (i.e., the one or more quantity) of the sub-tasks are propagated into the 8 am-12 pm and 1 pm-5 pm time intervals and coalesced such that each time interval of the coalesced set of time intervals includes a portion of the one or more quantity from the cumulative total of the one or more quantity. As should be understood, each task of the task hierarchy for the project would be coalesced by starting with the lowest tier of the hierarchy and working tier by tier to the highest tier of the hierarchy.

At step 135, the coalesced set of time intervals is traversed and the one or more progress variables are accumulated or totaled until the required progress for the progress variable determined in step 125 is reached. In embodiments, the coalesced set of time intervals may be traversed by starting at the earliest time interval and progressing through each time interval towards the latest time interval, and the one or more progress variables may be summed as each time interval is traversed until the required progress for the progress variable determined in step 125 is reached. If the point at which the required progress for the progress variable is reached does not lie on a time interval boundary (e.g., 12 pm may be a boundary of a time interval 8 am-12 pm), the coalesced time interval may be split such that the required progress for the progress variable is reached on a time interval boundary (e.g., the time interval 8 am-12 pm may be split into time intervals 8 am-10 am and 10 am-12 pm such that the required progress is reached on the time interval boundary of 10 am).

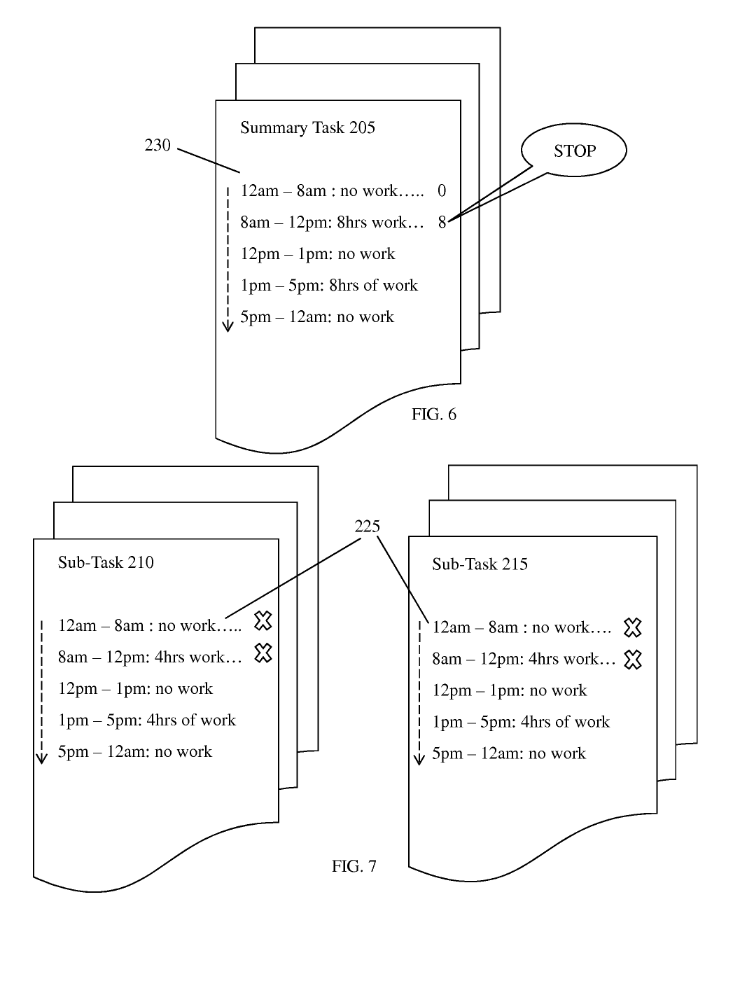

For example, as illustrated in FIG. 6 and continuing with the example discussed above, for summary task 205, the coalesced set of time intervals 230 is traversed starting at the earliest time interval (e.g., 12 am-8 am) and the work is accumulated until the one work day of required progress for the progress variable calculated in step 125 is reached. In this example, the one work day of required progress is reached at 12 pm once 8 hrs of work is completed since 8 hrs of work was previously defined as equal to one work day.

At step 140, the date of progress for the summary task is determined based on the end date of the interval at which the traversal in step 135 terminates. For example, continuing with the example discussed above, the date of progress for the summary task 205 corresponds to 12 pm of day 1, which is the end date of the time interval at which the traversal in step 135 terminates.

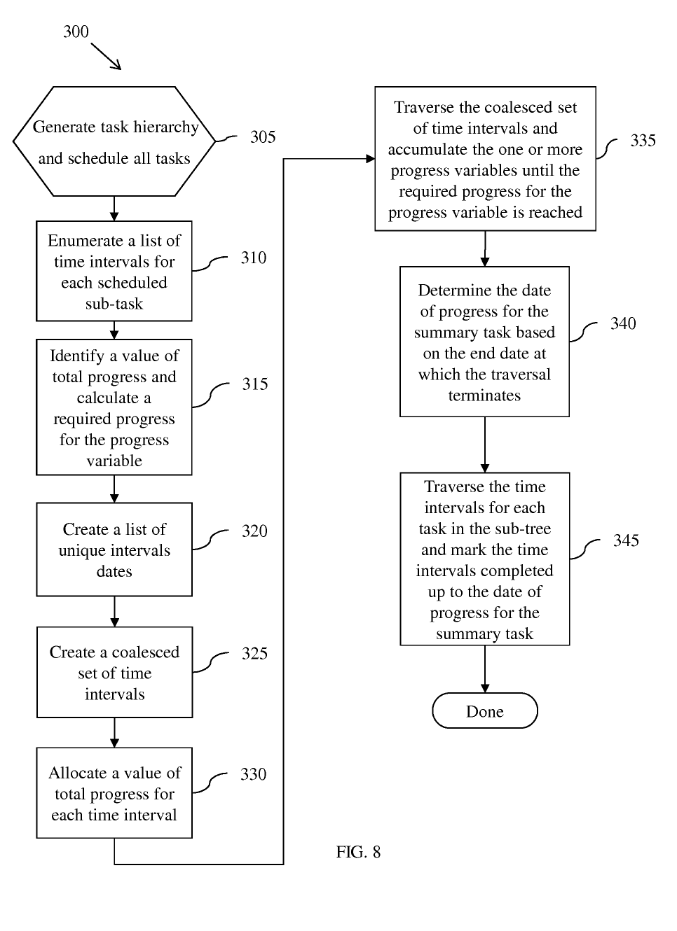

At step 145, for each task in the sub-tree, the corresponding time intervals are traversed and marked completed up to the date of progress for the summary task determined in step 140. For example, as illustrated in FIG. 7 and continuing with the example discussed above, the time intervals 225 for the sub-task 210 and the sub-task 215 are traversed and each time interval (e.g., 12 am-8 am and 8 am-12 pm) are marked completed up to the 12 pm of day date of progress for the summary task 205 determined in step 140.

Advantageously, in embodiments, all required intervals can be pre-calculated once scheduling is completed, thus reducing the computation time of applying the progress. Also advantageously, in embodiments, a non-uniform allocation of a quantity can be generated along the time intervals of a task such that it is possible to track progress of the quantity over duration of a task.

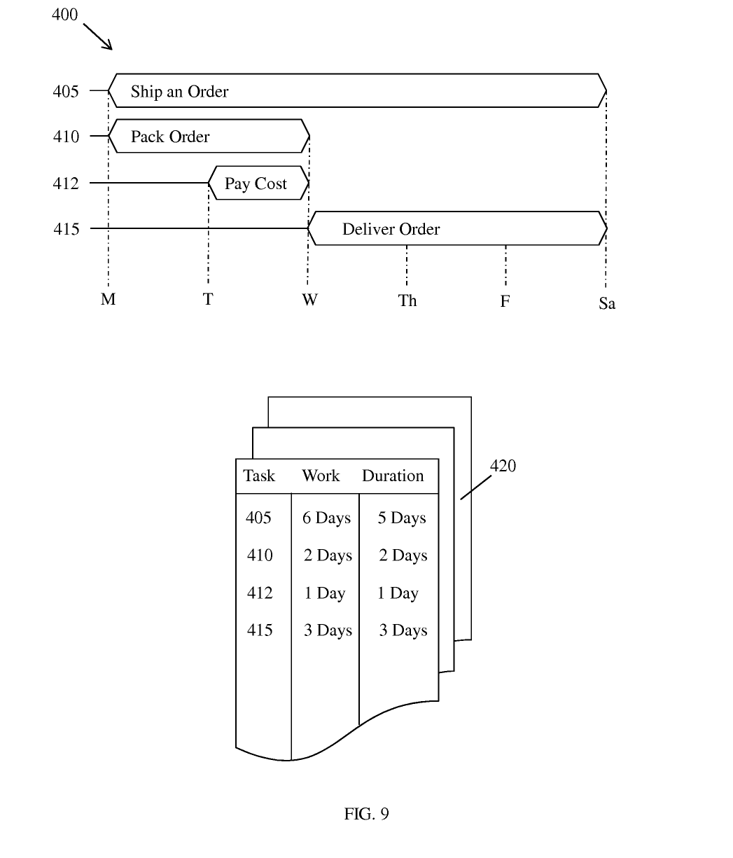

FIG. 8 depicts an exemplary flow for a process 300 in accordance with aspects of the present invention. At step 305, a task hierarchy for a project may be generated and scheduled using a computing device in a similar manner as that described with respect to steps 105 and 110 of FIG. 2. For example, as illustrated in FIG. 9, the scheduling of an exemplary task hierarchy for shipping an order, as performed in step 305, may result in a network diagram 400 having a summary task 405 (e.g., ship an order) with a duration of five days. The summary task 405 may include three sub-tasks 410, (e.g., pack the order), 412 (e.g., pay cost), and 415 (e.g., deliver the order). The sub-task 410 may have a duration of two days, the sub-task 412 may have a duration of 1 day, and the sub-task 415 may have a duration of 3 days. From the work breakdown structure 420 generated in step 205 it should be known that one day of work is equal to eight hours of work. Therefore, the sub-task 410 has a work value (i.e., a progress variable) of two work days or sixteen hours, the sub-task 412 has a work value of one work day or eight hours, and the sub-task 415 has a work value of three work days or twenty-four hours. Consequently, the cumulative work value of the summary task 405 is six work days or forty-eight hours, which is the sum total of the sub-tasks 410, 412, and 415 values of the work variable.

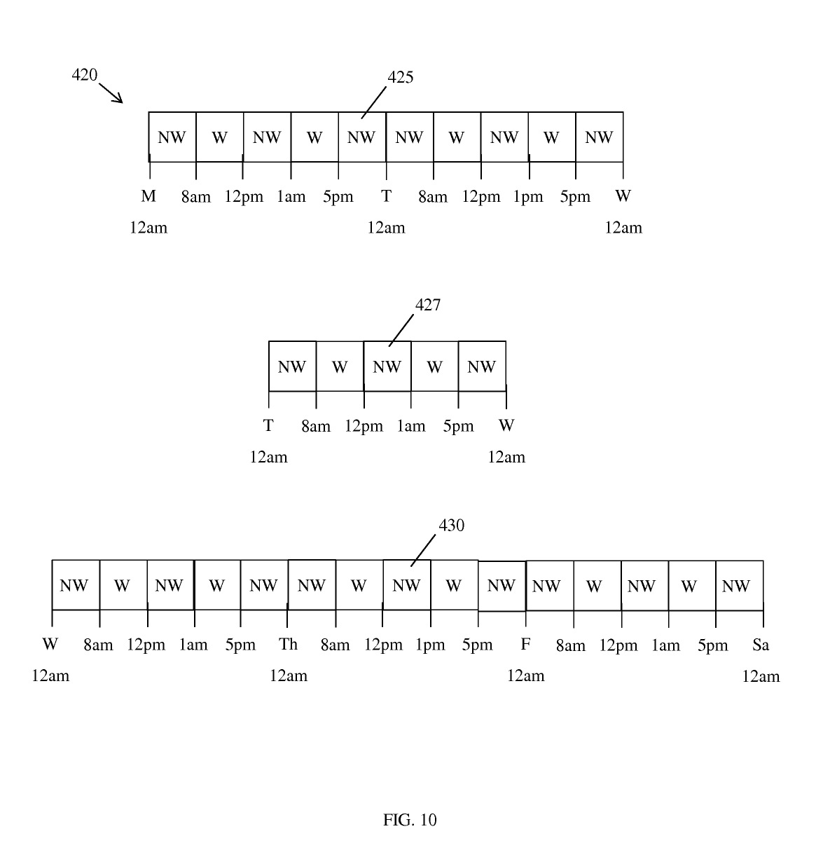

At step 310, a list of time intervals may be enumerated for each scheduled sub-task and propagated to include a quantity (e.g., one or more progress variables) that may be distributed over the duration of each scheduled sub-task in a similar manner as that described with respect to step 115 of FIG. 2. For example, as illustrated in FIG. 10 and continuing with the example discussed above, for sub-task 410, there may be ten time intervals 425 enumerated that represent a time from Monday 12 am-Wednesday 12 am. For sub-task 412, there may be five time intervals 427 enumerated that represent a time from Tuesday 12 am-Wednesday 12 am. For sub-task 415, there may be fifteen time intervals 430 enumerated that represent a time from Tuesday 12 am-Wednesday 12 am. Where work (i.e., the quantity) of the sub-tasks are distributed only to the Sam-12 pm and 1 pm-5 pm time intervals (e.g., working time (W)), and no work is distributed to the 12 am-8 am, 12 pm-1 pm, and 5 pm-12 am time intervals (e.g., non-working time (NW)). Consequently, each working interval has four hours of work associated, and each non-working interval has zero hours of work associated. All the time intervals represent uncompleted work assuming the hierarchy is initially set at zero percent completed.

At step 315, a value of total progress is identified for a summary task and a required progress for the progress variable may be calculated in a similar manner as that described with respect to steps 120 and 125 of FIG. 2. For example, continuing with the example discussed above, a value of 50% for total progress of the summary task 405 may be identified. The 50% total progress may be divided by 100 to obtain a 0.5 quotient, which is multiplied by the six cumulative work days calculated previously in step 305 to obtain three work days of required progress for the progress variable (i.e., work).

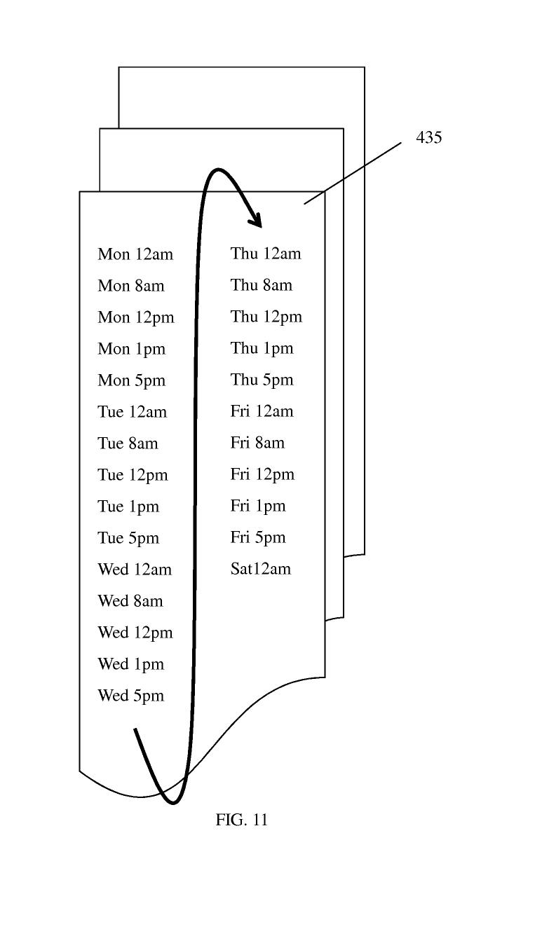

At step 320, a list of unique interval dates may be created for the summary task based on the enumerated list of time intervals for each sub-task. In embodiments, the list may be created in ascending order. For example, as illustrated in FIG. 11 and continuing with the example discussed above, a list 435 of unique interval dates for the summary task 405 by examining all the interval endpoints of the descendant or sub-tasks 410, 412, and 415 and creating a running list from Monday 12 am to Saturday 12 am (i.e., the period of time spanning the duration of the the descendant or sub-tasks 410, 412, and 415).

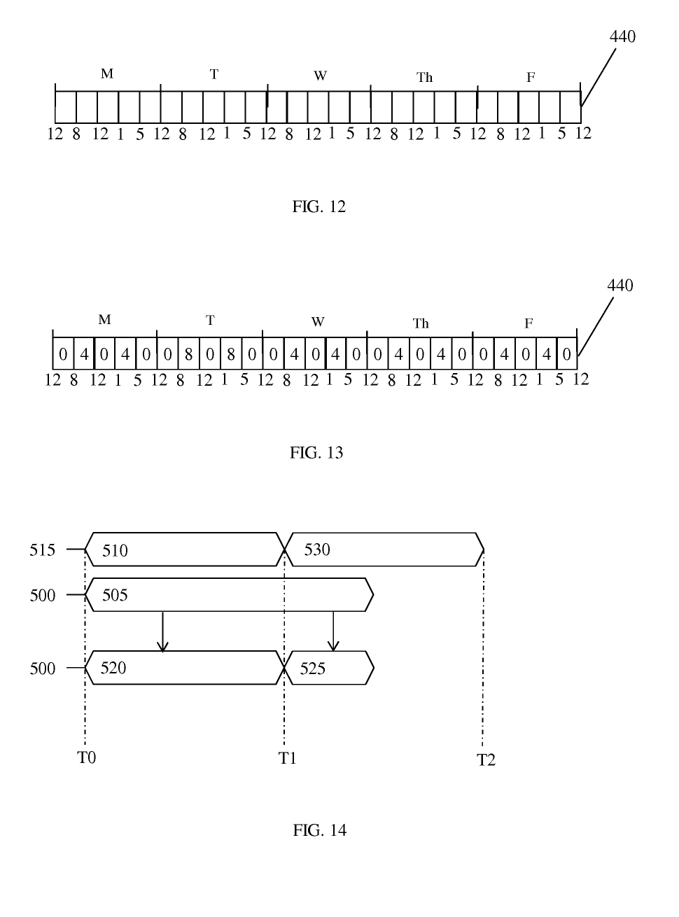

At step 325, a coalesced set of time intervals is created using the unique interval dates created in step 320. In embodiments, for N dates, N−1 work intervals will be created as a coalesced set of time intervals. For example, as illustrated in FIG. 12 and continuing with the example discussed above, a coalesced set of time intervals 440 comprising twenty-five time intervals is created using the twenty-six unique interval dates from the list 435.

At step 330, the value of total progress for each time interval of each sub-task is allocated to the coalesced time interval having the same starting date/time. In embodiments, the each time interval of each sub-task is iterated over and the value of total progress in each time interval is allocated to the coalesced time interval having the same starting date/time. Performing this process for each time interval of each sub-task results in propagation of the coalesced set of time intervals with a sub-total of the value of total progress for each time interval. For example, as illustrated in FIG. 13 and continuing with the example discussed above, the coalesced set of time intervals 440 is propagated such that each time interval includes a sub-total of the value of total progress for each time interval from the sub-tasks 410, 412, and 415.

In embodiments, if one of the sub-task time intervals is longer than the corresponding coalesced time interval, then the sub-task time interval may be split at the corresponding coalesced time interval end date. This may be performed by calculating the ratio of the corresponding coalesced time interval to the sub-task time interval and the sub-task time interval may be split into two equivalent portions using the calculated ratio. The progress quantities of each of the two equivalent portions should correspond to their respective portions of the sub-task time interval based on the calculated ratio. The progress quantities of each of the two equivalent portions may be allocated to the corresponding coalesced time interval and a subsequent coalesced time interval respectively. If the equivalent portion of the later sub-task time interval after the splitting is still longer than the subsequent coalesced time interval, then this step may be repeated to split the equivalent portion of the later sub-task time interval.

For example, as illustrated in FIG. 14, if sub-task 500 includes a time interval 505 that is longer than the corresponding coalesced time interval 510 for the coalesced set of time intervals 515, then the time interval 505 may be split at the corresponding coalesced time interval 510 such that the time interval 505 now comprises a first part 520 allocated to the corresponding coalesced time interval 510 and a second part 525 allocated to a subsequent coalesced time interval 530. T0, T1, and T2 are the time interval end points. The work is split and allocated according to the following equations (1) and (2).

Work₅₂₀=Total work₅₀₅*((T1−T0)/(T2−T0)) (1)

Work₅₂₅=Total work₅₀₅−Work₅₂₀ (2)

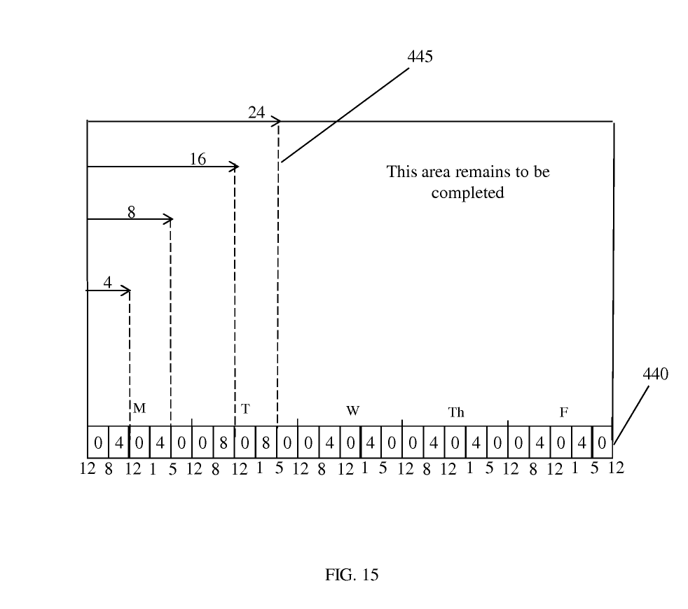

At step 335, the coalesced set of time intervals comprising the value of total progress for each time interval is traversed and the one or more progress variables are accumulated or totaled until the required progress for the progress variable determined in step 315 is reached in a similar manner as that described with respect to step 135 of FIG. 2. For example, as illustrated in FIG. 15 and continuing with the example discussed above, each time interval of the coalesced set of time intervals 440 is traversed until the sub-totals of the value of total progress for each time interval is accumulated to three days or twenty-four hours. If the point at which the required progress for the progress variable is reached does not lie on a time, the coalesced time interval may be split such that the required progress for the progress variable is reached on a time interval boundary.

At step 340, the date of progress for the summary task is determined based on the end date of the interval at which the traversal in step 335 terminates. For example, continuing with the example discussed above, the date of progress for the summary task 405 corresponds to 5 pm on Tuesday (shown in FIG. 15 as element 445), which is the end date of the time interval at which the traversal in step 335 terminates. At step 345, for each task in the sub-tree, the corresponding time intervals are traversed and marked completed up to the date of progress for the summary task determined in step 340 in a similar manner as that described with respect to step 140 of FIG. 2.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
enumerating a list of time intervals for each sub-task of at least one summary task;
distributing a progress value over a duration of each sub-task;
creating, by at least one computing device, a coalesced set of time intervals for the at least one summary task based on the list of time intervals enumerated for each sub-task;
traversing the coalesced set of time intervals and accumulating portions of the progress value until a required progress is obtained; and
determining a date of progress for the at least one summary task based on the accumulated portions of the progress value.

2. The method of claim 1, wherein the distributing the progress value comprises identifying a portion of the progress value for at least one time interval within the list of time intervals for each sub-task.

3. The method of claim 1, further comprising calculating the required progress for the progress value based on an identified value of total progress, wherein the value of total progress is representative of a total progress of performance for the at least one summary task up to a given date.

4. The method of claim 3, wherein the value of total progress is identified as a value between and inclusive of 0% and 100% by a user.

5. The method of claim 4, further comprising determining the progress value for each sub-task using a work break down structure comprising each sub-task.

6. The method of claim 5, wherein the required progress is calculated by dividing the value of total progress by one hundred to obtain a quotient, and multiplying the quotient by a cumulative value for the progress values determined for each sub-task.

7. The method of claim 1, further comprising propagating the portions of the progress value that are distributed over the duration of each sub-task into each time interval of the coalesced set of time intervals.

8. The method of claim 1, wherein a service provider at least one of creates, maintains, deploys and supports a computer infrastructure that includes the at least one computing device.

9. The method of claim 1, wherein steps of claim 1 are provided by a service provider on a subscription, advertising, and/or fee basis.

10. The method of claim 1, further comprising deploying a system for calculating the date of progress for the at least one summary task, comprising providing a computer infrastructure operable to perform the steps of claim 1.

11. A computer program product for calculating a date of progress for at least one summary task, the computer program product comprising a computer readable storage medium having program instructions embodied therewith, the program instructions executable by at least one computing device to cause the computing device to:
schedule all tasks of a task hierarchy including the at least one summary task;
enumerate a list of time intervals for each sub-task of the at least one summary task;
distribute a progress value over a duration of each sub-task;
calculate a required progress for the progress value based on an identified value of total progress;
create a list of unique interval dates based on the enumerated list of time intervals for each sub-task;
create a coalesced set of time intervals for the at least one summary task based on the list of unique interval dates;
propagate portions of the progress value that are distributed over the duration of each sub-task into each time interval of the coalesced set of time intervals;
traverse the coalesced set of time intervals and accumulate the portions of the progress value until the required progress is obtained; and
determine the date of progress for the at least one summary task based on the accumulated portions of the progress value.

12. The computer program product of claim 11, wherein the value of total progress is representative of a total progress of performance for the at least one summary task up to a given date.

13. The computer program product of claim 12, wherein the progress value is a work value, a cost value, or a resource value.

14. The computer program product of claim 13, wherein the program instructions are further executable by the at least one computing device to cause the computing device to traverse the time intervals for each sub-task and mark the time intervals completed up to the determined date of progress.

15. The computer program product of claim 14, wherein the distributing the progress value comprises identifying a portion of the progress value for at least one time interval within the list of time intervals for each sub-task.

16. A system comprising:
a CPU, a computer readable memory and a computer readable storage medium;
program instructions to enumerate a list of time intervals for each sub-task of at least one summary task;
program instructions to distribute a progress value over a duration of each sub-task;
program instructions to create a list of unique interval dates based on the enumerated list of time intervals for each sub-task;
program instructions to create a coalesced set of time intervals for the at least one summary task based on the list of unique interval dates;
program instructions to allocate portions of the progress value that are distributed over the duration of each sub-task to each time interval of the coalesced set of time intervals;
program instructions to traverse the coalesced set of time intervals and accumulate the portions of the progress value until a required progress is obtained;
program instructions to determine a date of progress for the at least one summary task based on the accumulated portions of the progress value; and
program instructions to traverse the time intervals for each sub-task and mark the time intervals completed up to the determined date of progress,
wherein the program instructions are stored on the computer readable storage medium for execution by the CPU via the computer readable memory.

17. The system of claim 16, further comprising program instructions to schedule all tasks of a task hierarchy including the at least one summary task, wherein the progress value is a work value, a cost value, or a resource value.

18. The system of claim 16, wherein the distributing the progress value comprises identifying a portion of the progress value for at least one time interval within the list of time intervals for each sub-task.

19. The system of claim 16, further comprising program instructions to calculate the required progress for the progress value based on an identified value of total progress, wherein the value of total progress is identified as a value between and inclusive of 0% and 100% by a user.

20. The system of claim 19, further comprising program instructions to determine the progress value for each sub-task using a work break down structure comprising each sub-task, wherein the required progress is calculated by dividing the value of total progress by one hundred to obtain a quotient, and multiplying the quotient by a cumulative value for the progress values determined for each sub-task.
